(19) United States
(12) Patent Application Publication
(10) Pub. No.: US 2013/0063274 A1
(43) Pub. Date: Mar. 14, 2013

(54) ALARM DETECTING METHOD AND COMPUTER DEVICE THEREOF

(71) Applicants: Thi-Huyen Nguyen, New Taipei City (TW); Jui-Ta Hsieh, New Taipei City (TW)

(72) Inventors: Thi-Huyen Nguyen, New Taipei City (TW); Jui-Ta Hsieh, New Taipei City (TW)

(21) Appl. No.: 13/412,629

(22) Filed: Mar. 6, 2012

(30) Foreign Application Priority Data
Sep. 9, 2011 (TW) 100132676

(51) Int. Cl. G08B 21/00

(52) U.S. Cl. 340/669

(57) ABSTRACT

An alarm detecting method applied on a computer device is disclosed in the present invention. The method includes utilizing a G-sensor of the computer device to detect a variation of gravity acceleration, transmitting an actuating signal to a controller by the G-sensor according to the variation of the gravity acceleration, the controller reading the actuating signal and determining whether the variation of the gravity acceleration is substantially greater than a predetermined threshold value, the controller outputting a controlling signal to an audio codec when the variation of the gravity acceleration is substantially greater than the predetermined threshold value, and a speaker generating an alarm audio by the audio codec according to the controlling signal. The controller drives the speaker to generate the alarm audio when an operating system of the computer device has not started.

### BACKGROUND OF THE INVENTION

1. Field of the Invention

The present invention relates to a alarm detecting method and a computer device thereof, and more particularly, to a alarm detecting method and a computer device thereof for earthquake warning and robbery warning.

2. Description of the Prior Art

A conventional portable computer, such as a notebook computer or a tablet computer, is easy to be stolen due to its conveyable property. For preventing the portable computer from being stolen, a cable lock made of metal material is utilized for constraining a movement of the portable computer. An end of the cable lock is fixed at the portable computer, and the other end of the cable lock is disposed on a stable frame, so that the movement of the portable computer can not be greater than a length of the cable lock. However, the cable lock has huge volume and heavy weight, and the cable lock is co-operated with the stable frame. Therefore, design of a theft prevention method for effectively saving the portable computer is an important issue in the computer industry.

### SUMMARY OF THE INVENTION

The present invention provides a alarm detecting method and a computer device thereof for earthquake warning and robbery warning for solving above drawbacks.

According to the claimed invention, a alarm detecting method includes utilizing a G-sensor of a computer device to detect a variation of gravity acceleration, transmitting an actuating signal to a controller by the G-sensor according to the variation of the gravity acceleration, reading the actuating signal by the controller and determining whether the variation of the gravity acceleration is substantially greater than a predetermined threshold value, outputting a controlling signal to an audio codec by the controller when the variation of the gravity acceleration is substantially greater than the predetermined threshold value, and driving a speaker to generate an alarm audio by the audio codec according to the controlling signal.

According to the claimed invention, the controller drives the speaker to generate the alarm audio via the audio codec when an operating system of the computer device has not started.

According to the claimed invention, the method further includes outputting a starting signal to a logic unit by the controller for starting the operating system when the variation of the gravity acceleration is substantially greater than the predetermined threshold value.

According to the claimed invention, the method further includes driving the logic unit to outputting another controlling signal to the audio codec after the operating system has started, and driving the speaker to generate an alarm signal by the audio codec according to the controlling signal.

According to the claimed invention, the G-sensor and the controller are driven by an auxiliary power supply.

According to the claimed invention, the G-sensor detects the gravity acceleration when the operating system of the computer device has not started.

According to the claimed invention, the alarm audio and the alarm signal are earthquake warnings when the variation of the gravity acceleration is within a first threshold interval.

According to the claimed invention, the alarm audio and the alarm signal are robbery warnings when the variation of the gravity acceleration is within a second threshold interval.

According to the claimed invention, a computer device includes a G-sensor for detecting a variation of gravity acceleration and for outputting an actuating signal according to the variation of the gravity acceleration, a controller electrically connected to the G-sensor for reading the actuating signal and outputting a controlling signal when the variation of the gravity acceleration is substantially greater than a predetermined threshold value, a speaker, and an audio codec electrically connected to the controller and the speaker for receiving the controlling signal and driving the speaker to generate an alarm audio according to the controlling signal.

According to the claimed invention, the computer device further includes a logic unit electrically connected to the controller and the audio codec for receiving a starting signal outputted by the controller to start the operating system when the variation of the gravity acceleration is substantially greater than the predetermined threshold value.

According to the claimed invention, the logic unit is further for outputting another controlling signal to the audio codec after the operating system has started, so as to drive the speaker to generate an alarm signal.

The alarm detecting method and the computer device of the present invention do not utilize extra component, and can utilize the built-in G-sensor to detect the movement or the vibration of the computer device, so as to warn the user that the computer device is stolen. In addition, the present invention can further utilize the G-sensor to detect the earthquake wave for providing early warning. Thus, the alarm detecting method and the computer device of the present invention can effectively provide the robbery warning and the earthquake warning by detecting the vibration.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional diagram of a computer device according to an embodiment of the present invention.

FIG. 2 is a flow chart of an alarm detecting method of the computer device according to the embodiment of the present invention.

### DETAILED DESCRIPTION

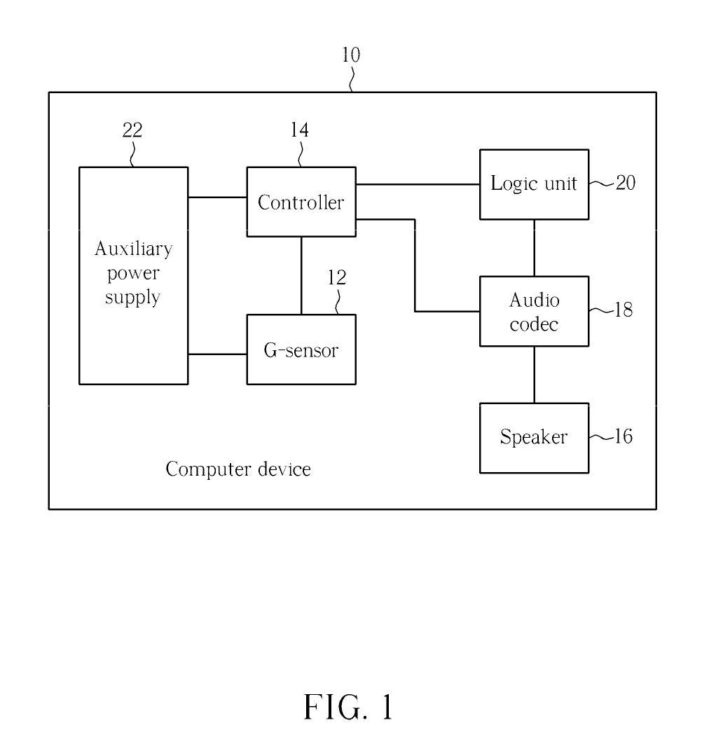

Please refer to FIG. 1. FIG. 1 is a functional diagram of a computer device 10 according to an embodiment of the present invention. The computer device 10 can be a portable computer device having earthquake detecting function or robbery warning function, such as a notebook computer or a tablet computer. The computer device 10 can utilize a G-sensor to detect slight variation of movement or vibration. The computer device 10 includes a G-sensor 12, a controller 14, a speaker 16, an audio codec 18 and a logic unit 20. The G-sensor 12 is for detecting a variation of gravity acceleration, for example, the G-sensor 12 can detect a vibration (the variation of the gravity acceleration) when the computer device 10 is moved, and the G-sensor 12 can output an actuating signal, such as IRQ pin, to the controller 14 when the gravity acceleration is varied. The controller 14 can be an embedded controller, such as an I/O controller, electrically connected to the G-sensor 12 for reading the actuating signal via I2C interface. The controller 14 can further compare a difference between a predetermined threshold value and the variation of the gravity acceleration, so as to output a corresponding controlling signal. The audio codec 18 is electrically connected to the controller 14 and the speaker 16 for receiving the controlling signal, and for driving the speaker 16 to generate an alarm audio according to the controlling signal.

In addition, the computer device 10 can further include an auxiliary power supply 22 electrically connected to the G-sensor 12 and the controller 14. The auxiliary power supply 22 can supply power to the G-sensor 12 and the controller 14 before an operating system of the computer device 10 has not started. Thus, the G-sensor 12 can detect the variation of the gravity acceleration when the computer device 10 has not started, so as to generate the corresponding alarm according to a comparison of the predetermined threshold value and the variation of the gravity acceleration.

As the controller 14 determines that the variation of the gravity acceleration is not greater the predetermined threshold value, the computer device 10 might be touched unexpectedly, and the vibration detected by the G-sensor 12 is slight, so the speaker 16 does not generate alarm. However, the controller 14 can determines that the variation of the gravity acceleration is substantially greater the predetermined threshold value when the computer device 10 is hit violently, such as earthquake wave or unallowable movement, and then the controller 14 can drive the speaker 16 to generate the alarm audio via the audio codec 18, so as to execute the warning function.

Furthermore, the logic unit 20 can be a south bridge circuit electrically connected to the controller 14 and the audio codec 18. The controller 14 not only can output the controlling signal to drive the audio codec 18 and the speaker 16, but also can output a starting signal to the logic unit 20 when the controller 14 determines that the variation of the gravity acceleration is substantially greater the predetermined threshold value. The logic unit 20 can drive BIOS to start the operating system and the computer device 10 after receiving the starting signal. Then, the operating system can drive the logic unit 20 to output the other controlling signal to the audio codec 18 after starting, so as to control the speaker 16 to generate an alarm signal different from the alarm audio. Generally, the alarm audio can be beep audio, and the alarm signal can be generated via application program of the operating system, so that the alarm signal can include multimedia information, such as an image signal, an audio signal or a symbol signal, for providing detail information of the alarm.

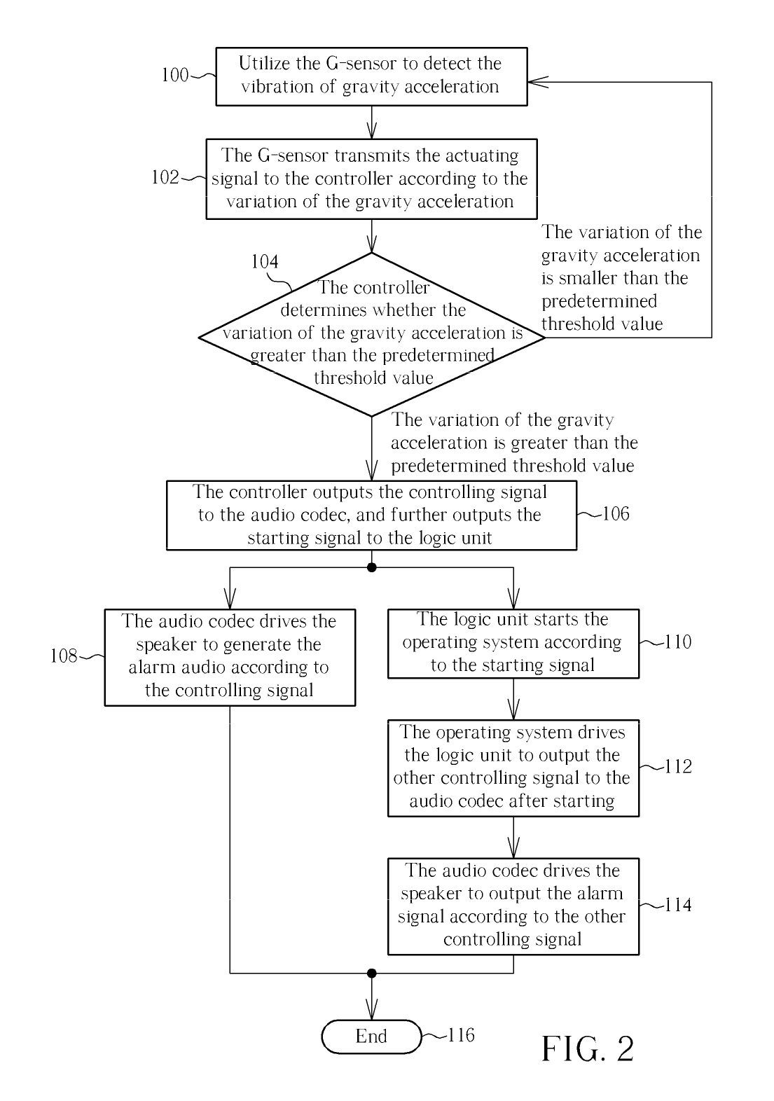

Please refer to FIG. 2. FIG. 2 is a flow chart of an alarm detecting method of the computer device 10 according to the embodiment of the present invention. The method includes following steps:

Step 100: Utilize the G-sensor 12 to detect the vibration of the gravity acceleration, wherein the G-sensor 12 detects the gravity acceleration when the computer device 10 has not started.

Step 102: The G-sensor 12 transmits the actuating signal to the controller 14 according to the variation of the gravity acceleration.

Step 104: The controller 14 determines whether the variation of the gravity acceleration is greater than the predetermined threshold value. Execute step 100 when the variation of the gravity acceleration is smaller than the predetermined threshold value. Execute step 106 when the variation of the gravity acceleration is greater than the predetermined threshold value.

Step 106: The controller 14 outputs the controlling signal to the audio codec 18, and execute step 108. The controller 14 outputs the starting signal to the logic unit 20, and execute step 110.

Step 108: The audio codec 18 drives the speaker 16 to generate the alarm audio according to the controlling signal, and execute step 116.

Step 110: The logic unit 20 starts the operating system according to the starting signal, and execute step 112.

Step 112: The operating system drives the logic unit 20 to output the other controlling signal to the audio codec 18 after starting, and execute step 114.

Step 114: The audio codec 18 drives the speaker 16 to output the alarm signal according to the other controlling signal, and execute step 116.

Step 116: End.

Detailed description of the method is introduced as follows. The G-sensor 12 and the controller 14 of the computer device 10 are electrically connected to the auxiliary power supply 22, so the G-sensor 12 can detect the variation of the gravity acceleration when the computer device 10 has not started. When the G-sensor 12 detects that the gravity acceleration is varied, the G-sensor 12 can transmit the actuating signal to the controller 14, and the controller 14 starts to determine the difference between the variation of the gravity acceleration and the predetermined threshold value. As the variation of the gravity acceleration is smaller than the predetermined threshold value, the controller 14 does not output commands. As the variation of the gravity acceleration is substantially greater than the predetermined threshold value, which means the computer device 10 can detect the earthquake wave or might be stolen (that is determined according to the variation of the gravity acceleration), the controller 14 can output the controlling signal to the audio codec 18, so as to drive the speaker 16 to generate the alarm audio. Therefore, the alarm detecting method and the computer device 10 of the present invention can immediately generate the alarm audio when the G-sensor 12 detects the variation of the gravity acceleration, so that the user can react quickly according to the alarm audio, such as hiding in earthquake or catching a thief who steals the computer device 10.

For determining the alarm content, the predetermined threshold value can be divided into a first threshold interval, such as 8°˜20°, and a second threshold interval, such as 21°˜360°. As the variation of the gravity acceleration detected by the G-sensor 12 is between 8°˜20°, the G-sensor 12 can detect the earthquake wave, and the controller 14 can drive the speaker 16 to generate intermittent long beep as the earthquake warning via the audio codec 18. As the variation of the gravity acceleration detected by the G-sensor 12 is between 21°˜360°, which means the G-sensor 12 shakes violently, the computer device 10 may be stolen (the unallowable movement), and the controller 14 can drive the speaker 16 to generate rapid short beep as the robbery warning via the audio codec 18. Therefore, the controller 14 of the present invention can drive the speaker 16 to generate the earthquake warning or the robbery warning according to the variation of the gravity acceleration detected by the G-sensor 12. Values of the threshold interval and frequency of the warnings are not limited to the above-mentioned embodiment, and depend on design demand.

In addition, the controller 14 can wake the computer device 10, which means starting the operating system of the computer device 10, at the time of generating the alarm audio when detecting that the variation of the gravity acceleration is substantially greater than the predetermined threshold value. For example, the controller 14 can output the starting signal to the logic unit 20 when the variation of the gravity acceleration is substantially greater than the predetermined threshold value, so that the BIOS and the operating system can be started sequentially by the logic unit 20. The BIOS can drive the speaker 16 to generate the alarm signal via the logic unit 20 and the audio codec 18 selectively after starting. Further, the operating system can execute corresponding applications via WMI after ACPI function is executed, so as to generate the alarm signal having the multimedia information, such as the image signal, the audio signal, the symbol signal and so on. The multimedia alarm signal can provide detailed information, which is sensible than the alarm audio generated by the controller 14 via the speaker 16, so that the user can read information of the warnings clearly.

In conclusion, the alarm detecting method and the computer device of the present invention can supply power to the G-sensor by the auxiliary power supply, so that the G-sensor can detect the variation of the gravity acceleration when the computer device has not started. The controller can determine the vibration is generated by earthquake or robbery according to the variation of the gravity acceleration, and drive the speaker to generate the simple alarm audio via the audio codec. Meanwhile, the controller can output the starting signal to the logic unit for starting the BIOS and the operating system, so as to utilize the multimedia program of the operating system to generate the alarm signal having detailed information.

Comparing to the prior art, the alarm detecting method and the computer device of the present invention do not utilize extra component, and can utilize the built-in G-sensor to detect the movement or the vibration of the computer device, so as to warn the user that the computer device is stolen. In addition, the present invention can further utilize the G-sensor to detect the earthquake wave for providing early warning. Thus, the alarm detecting method and the computer device of the present invention can effectively provide the robbery warning and the earthquake warning by detecting the vibration.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A alarm detecting method comprising:
utilizing a G-sensor of a computer device to detect a variation of gravity acceleration;
transmitting an actuating signal to a controller by the G-sensor according to the variation of the gravity acceleration;
reading the actuating signal by the controller and determining whether the variation of the gravity acceleration is substantially greater than a predetermined threshold value;
outputting a controlling signal to an audio codec by the controller when the variation of the gravity acceleration is substantially greater than the predetermined threshold value; and
driving a speaker to generate an alarm audio by the audio codec according to the controlling signal.

2. The method of claim 1, wherein the controller drives the speaker to generate the alarm audio via the audio codec when an operating system of the computer device has not started.

3. The method of claim 2, further comprising:
outputting a starting signal to a logic unit by the controller for starting the operating system when the variation of the gravity acceleration is substantially greater than the predetermined threshold value.

4. The method of claim 3, further comprising:
driving the logic unit to outputting another controlling signal to the audio codec after the operating system has started; and
driving the speaker to generate an alarm signal by the audio codec according to the controlling signal.

5. The method of claim 1, wherein the G-sensor and the controller are driven by an auxiliary power supply.

6. The method of claim 2, wherein the G-sensor detects the gravity acceleration when the operating system of the computer device has not started.

7. The method of claim 4, wherein the alarm audio and the alarm signal are earthquake warnings when the variation of the gravity acceleration is within a first threshold interval.

8. The method of claim 4, wherein the alarm audio and the alarm signal are robbery warnings when the variation of the gravity acceleration is within a second threshold interval.

9. A computer device comprising:
a G-sensor for detecting a variation of gravity acceleration, and for outputting an actuating signal according to the variation of the gravity acceleration;
a controller electrically connected to the G-sensor for reading the actuating signal and outputting a controlling signal when the variation of the gravity acceleration is substantially greater than a predetermined threshold value;
a speaker; and
an audio codec electrically connected to the controller and the speaker for receiving the controlling signal and driving the speaker to generate an alarm audio according to the controlling signal.

10. The computer device of claim 9, wherein the controller drives the speaker to generate the alarm audio via the audio codec when an operating system of the computer device has not started.

11. The computer device of claim 9, further comprising:
a logic unit electrically connected to the controller and the audio codec for receiving a starting signal outputted by the controller to start the operating system when the variation of the gravity acceleration is substantially greater than the predetermined threshold value.

12. The computer device of claim 11, wherein the logic unit is further for outputting another controlling signal to the audio codec after the operating system has started, so as to drive the speaker to generate an alarm signal.

13. The computer device of claim 9, further comprising:
an auxiliary power supply electrically connected to the G-sensor and the controller for supplying power to the G-sensor and the controller when the operating system has not started.

14. The computer device of claim 10, wherein the G-sensor detects the gravity acceleration when the operating system of the computer device has not started.

15. The computer device of claim 9, wherein the alarm audio and the alarm signal are earthquake warnings when the variation of the gravity acceleration is within a first threshold interval.

16. The computer device of claim 9, wherein the alarm audio and the alarm signal are robbery warnings when the variation of the gravity acceleration is within a second threshold interval.
